(19) United States
(12) Patent Application Publication
(10) Pub. No.: US 2015/0208203 A1
(43) Pub. Date: Jul. 23, 2015

(54) METHOD AND APPARATUS FOR PROVIDING TRANSPORTATION BASED RECOMMENDER SYSTEM

(71) Applicants: Huanhuan Cao, Beijing (CN); Jilei Tian, Beijing (CN)

(72) Inventors: Huanhuan Cao, Beijing (CN); Jilei Tian, Beijing (CN)

(73) Assignee: Nokia Corporation, Espoo (FI)

(21) Appl. No.: 14/409,567

(22) PCT Filed: Jun. 25, 2012
(86) PCT No.: PCT/CN2012/077425

§ 371 Date: Dec. 19, 2014

(51) Int. Cl. H04W 4/02; G06F 17/30; H04M 1/725

(52) U.S. Cl. CPC H04W 4/028; H04M 1/72572; H04M 1/72569; G06F 17/30241

(57) ABSTRACT

An approach for recommending location-based content items that account for locations with ease of access based on available transportation options is described. A content recommender platform determines one or more predicted locations of a user based, at least in part, on an ease of access from a location associated with the use. The content recommender platform determines one or more location-based content items associated with the one or more predicted locations, the location, or a combination thereof. The content recommender platform determines one or more recommended content items from among the one or more location-based content items. In this way, the recommended content items may be easily accessible and may accord with the user's preferences.

### BACKGROUND

Service providers and device manufacturers (e.g., wireless, cellular, etc.) are continually challenged to deliver value and convenience to consumers by, for example, providing compelling network services. One area of interest has been the development of location-based services and technologies, and in particular, location-based recommender systems. By way of example, location-based recommender systems help a user to sift through the increasing number of available services and related content items to discover potential items of interest based on the user's location. However, filtering recommendations based on the user's location can unnecessarily eliminate potential items of interest that could otherwise be presented to users. As a result, service providers and device manufacturers face significant technical challenges to expanding the pool of services and content items from which location-based recommender systems can make recommendations to users.

### SOME EXAMPLE EMBODIMENTS

Therefore, there is a need for an approach for recommending location-based content items that account not only for the user's current location but also for locations where users can access or are predicted to be based, for instance, on available transportation options.

According to one embodiment, a method comprises determining one or more predicted locations of a user based, at least in part, on an ease of access from a location associated with the user. The method also comprises determining one or more location-based content items associated with the one or more predicted locations, the location, or a combination thereof. The method further comprises determining one or more recommended content items from among the one or more location-based content items,

According to another embodiment, an apparatus comprises at least one processor, and at least one memory including computer program code for one or more computer programs, the at least one memory and the computer program code configured to, with the at least one processor, cause, at least in part, the apparatus to determine one or more predicted locations of a user based, at least in part, on an ease of access from a location associated with the user. The apparatus is also caused to determine one or more location-based content items associated with the one or more predicted locations, the location, or a combination thereof. The apparatus is further caused to determine one or more recommended content items from among the one or more location-based content items.

According to another embodiment, a computer-readable storage medium carries one or more sequences of one or more instructions which, when executed by one or more processors, cause, at least in part, an apparatus to determine one or more predicted locations of a user based, at least in part, on an ease of access from a location associated with the user. The apparatus is also caused to determine one or more location-based content items associated with the one or more predicted locations, the location, or a combination thereof. The apparatus is further caused to determine one or more recommended content items from among the one or more location-based content items.

According to another embodiment, an apparatus comprises means for determining one or more predicted locations of a user based, at least in part, on an ease of access from a location associated with the user. The apparatus also comprises means for determining one or more location-based content items associated with the one or more predicted locations, the location, or a combination thereof. The apparatus further comprises means for determining one or more recommended content items from among the one or more location-based content items.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-22 and 38-41.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of recommending location-based content items that account for locations with ease of access based on available transportation options, according to one embodiment;

FIG. 2 is a diagram of the components of a content recommender platform, according to one embodiment;

FIGS. 3A-3E are flowcharts of processes for recommending location-based content items that account for locations with ease of access based on available transportation options, according to various embodiment;

FIGS. 4A-4C are diagrams of user interfaces utilized in the processes of FIGS. 3A-3E, according to various embodiments;

FIGS. 5A-5B are diagrams illustrating a process of indexing the location-based contents with the transportation hubs, according to various embodiments;

FIG. 6 is a diagram illustrating a process of sequential programming of the plurality of the recommended content items, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for recommending location-based content items that account for locations with ease of access based on available transportation options are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention,

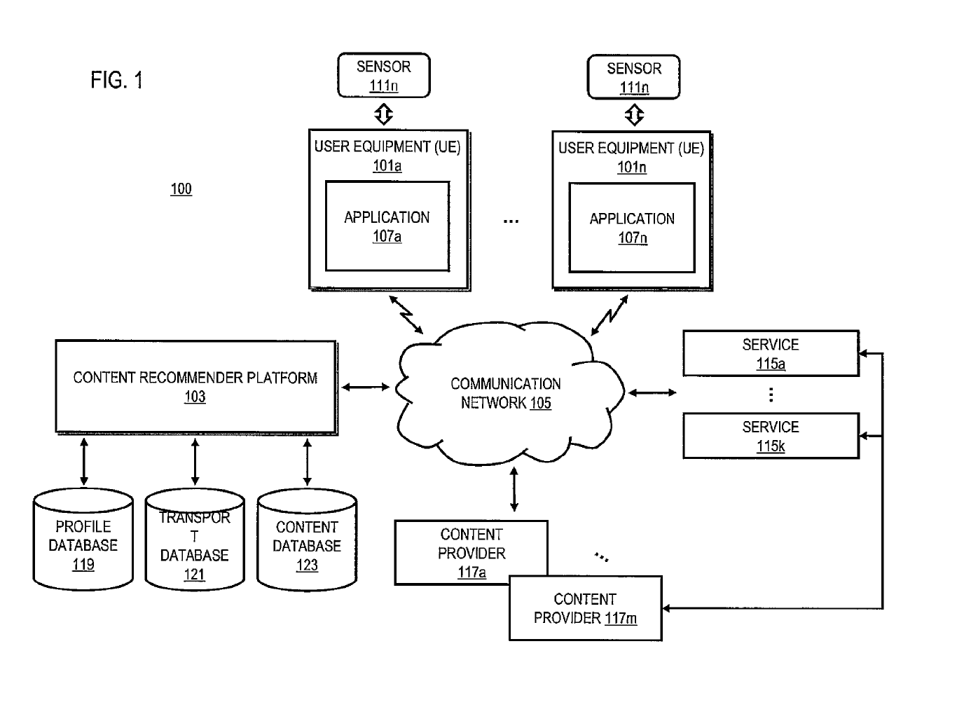

FIG. 1 is a diagram of a system capable of recommending location-based content items that account for locations with ease of access based on available transportation options, according to one embodiment. Typically, location-based recommender services present advertisements or contents (e.g., places, deals, activities, etc.) associated with user locations. However, such recommender services have not traditionally accounted for ease of access to a destination provided, for instance, by public transportation or other transportation means available from a user's current location. Consequently, certain location-based services or content items may not be recommended to a user even though those services could easily be accessed by the user via available transportation options.

To address this problem, a system 100 of FIG. 1 introduces the capability to recommend location-based content items that account for locations with ease of access based on available transportation options. The ease of access may be the most convenient means or the least overhead cost to access the content items. In certain embodiments, the system 100 may comprise a profile database 119 which maintains data associated with user profile. The user profile may include a name, an access id, a password, an email, an address, credit card information, preference, history, etc. For example, the user profile may be processed by a content recommender platform 103 as a basis for authenticating an access to the content recommender platform 103 or in determining the recommended content items based on user preference via an application 107.

In certain embodiments, the system 100 may comprise a transport database 121 which maintains data associated with transport information. The transport information may include information associated with maps, routes, transportation hubs (e.g., stations, terminals, stops, harbors, docks, airports, parking lots, etc.), public transportations (e.g., subway, bus, train, etc.), traffics, etc. For example, the transport information may be processed by the content recommender platform 103 as bases in determining travel time, distance, or ease of access from a location of a user to predicted locations associated with content items.

In certain embodiments, the system 100 may comprise a content database 123 which maintains data associated with location-based content items. The location-based content items may be associated with places, deals, activities, etc. Examples of the location-based content items are advertisements, discount coupons, restaurant recommendations, or event notifications. The location-based content items may be provided by a content provider 117. The location-based content items may be indexed to the transportation hubs for fast retrieval in future searches. The location-based content items may be retrieved by the content recommender platform 103 to be ranked and recommended for users.

In certain embodiments, the system 100 may comprise a content provider 117 which provides location-based content items to the content recommender platform 103. The content provider 117 may generate the location-based content items associated with places, deals, activities, etc. The content provider 117 may interact with a service 115 to provide the location-based content items to the service 115 and receive feedbacks on the location-based content items. It is noted that the content provider 117 may operate with the content recommender platform 103 and the service 115 via the communication network 105.

In certain embodiments, the system 100 may comprise a service 115 which may generate feedback information associated with the location-based content items. The service 115 may include recommender services, social networking services, etc. The service may manually generate the feedback information or allow users to leave the feedback information spontaneously on its platform. The feedback information may be captured by the content recommender platform 103 as bases in determining recommended content items. It is noted that the service 115 may operate with the content recommender platform 103 and the content provider 117 via the communication network 105.

In certain embodiments, the system 100 may comprise a content recommender platform 103 which is configured to recommend content items that account for locations with ease of access based on available transportation options. The content recommender platform 103 may receive and process data from the profile database 119, the transport database 121, and the content database 123 as bases in filtering the location-based content items, ranking the filtered content items, and determining recommended content items among from the ranked content items. The content recommender platform 103 may also receive or capture the feedback information from the service 115. The feedback information may be processed as bases in ranking the location-based content items for recommendation. The content recommender platform 103 may interact with user equipment (UE) 101 via application 107 to perform a determination of recommended content items that account for locations with ease of access based on available transportation options. It is noted that the content recommender platform 103 may operate with the UE 101, the service 115, and the content provider 117 via the communication network 105.

In certain embodiments, the system 100 may comprise application 107 which is configured to interact with the content recommender platform 103 and to present information received from the content recommender platform 103. The application 107 may include content item recommender application capable of presenting recommended content items that account for locations with ease of access based on available transportation options. For example, the application 107 may enable UE 101 to transmit information associated with the user (e.g., user location, user profile, user input, etc.) to the content recommender platform 103 and to receive information associated with recommended content items that account for locations with ease of access based on available transportation options. User interface (UI) implemented by the application 107 may enable users to enter the information to be transmitted to the content recommender platform 103 and may visualize information received from the content recommender platform 103. It is noted that the application 107 may operate with content recommender platform 103 via the communication network 105.

In certain embodiments, the system 100 may comprise sensor 111. The sensor 111 may include global positioning sensor, temporal sensor, motion sensor, accelerometer, gyroscope, network detection sensor, etc. The sensor 111 may be installed in the UE 101. Also, the UE 101 may receive sensor information from the sensor 111. The sensor information may be transmitted from the UE 101 to the content recommender platform 103. For example, location information determined by the global positioning sensor may be transmitted to the content recommender platform 103, where the location information may be processed as bases in determining transport routes or transportation hubs nearby.

The system 100 may comprises a user equipment (UE) 101 having connectivity to content recommender platform via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof; including the accessories and peripherals of these devices, or any combination thereof. It is also contemplated that the UE 101 can support any type of interface to the user (such as “wearable” circuitry, etc.).

By way of example, the UE 101, content recommender platform 103, service 115, and content provider 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

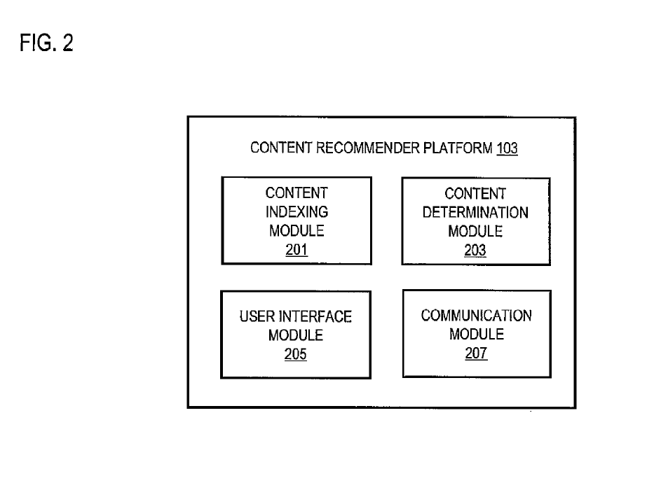

FIG. 2 is a diagram of the components of content recommender platform 103, according to one embodiment. By way of example, the content recommender platform 103 includes one or more components for recommending location-based content items that account for locations with ease of access based on available transportation options. The ease of access may be the most convenient means or the least overhead cost to access the content items. It is contemplated that the functions of these components may be combined in one or more components or performed by other components of equivalent functionality. In this embodiment, the content recommender platform includes a content indexing module 201, a content determination module 203, a user interface module 205, and a communication module 207.

In one embodiment, the content indexing module 201 may enable indexing location-based content items to nearby transportation hubs. The indexing creates content-location indices which allow fast retrieving of the location-based content items in future searches. The information associated with the location-based content items may be received from the content provider 117 via a communication module 207 through the communication network 105. The indexed content items may be retrieved by the content determination module 203 for a determination of recommended content items.

In one embodiment, the content determination module 203 may enable determining recommended content items that account for locations with ease of access based on available transportation options. The content determination module may determine the location-based content items based on a location of a user. The determined content items may be filtered based on parameters associated with the ease of access. The parameters may include user inputs or user preferences. The filtered content items may be ranked based on features and weights of the filtered content items. Among the ranked content items, high-ranked content items may be determined as the recommended content items. Information associated with the recommend content items may be communicated to UE 101 via communication module 207 through communication network 105.

In one embodiment, the user interface module 205 may enable presentment of a graphical user interface for presenting recommended content items that account for locations with ease of access based on available transportation options. For example, the user interface module 205 may generate the interface in response to application programming interface (APIs) or other function calls corresponding to the application 107 or UE 101, thereby enabling the display of graphics primitives, such as menus, buttons, data entry fields, etc. Further, the user interface module 205 may enable the presentment of the recommended content items that account for locations with ease of access based on available transportation options. It is noted that the user interface module 205 may be configured to operate in connection with content determination module 203 to present the recommended content items via application 107 in response to the user inputs.

In one embodiment, the communication module 207 enables formation of a session over a network 105 between the content recommender platform 103 and the UE 101. For example, the communication module 207 executes various protocols and data sharing techniques for enabling collaborative execution between UE 101 and the content recommender platform 103 over the network 105.

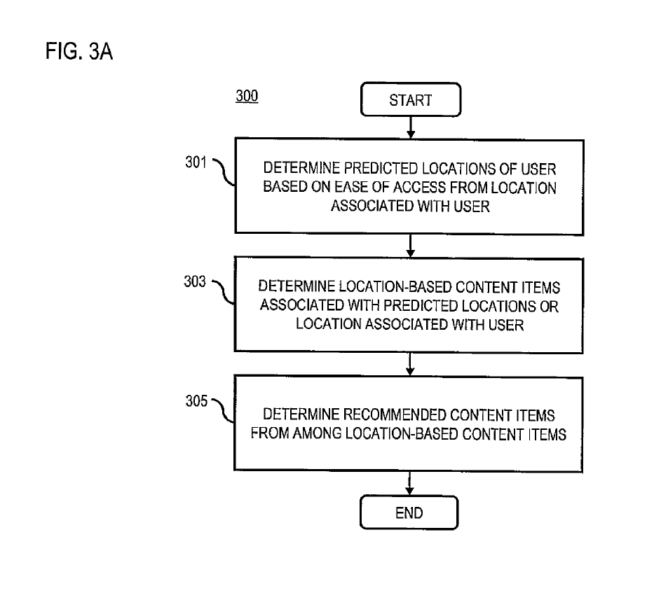

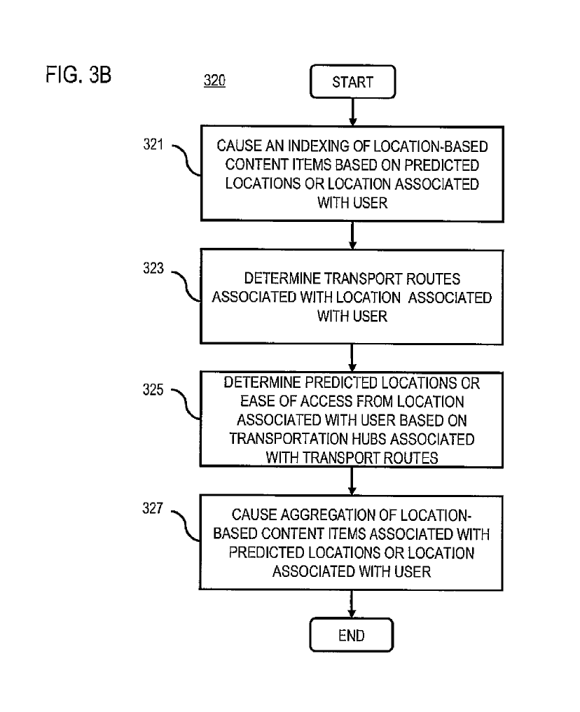

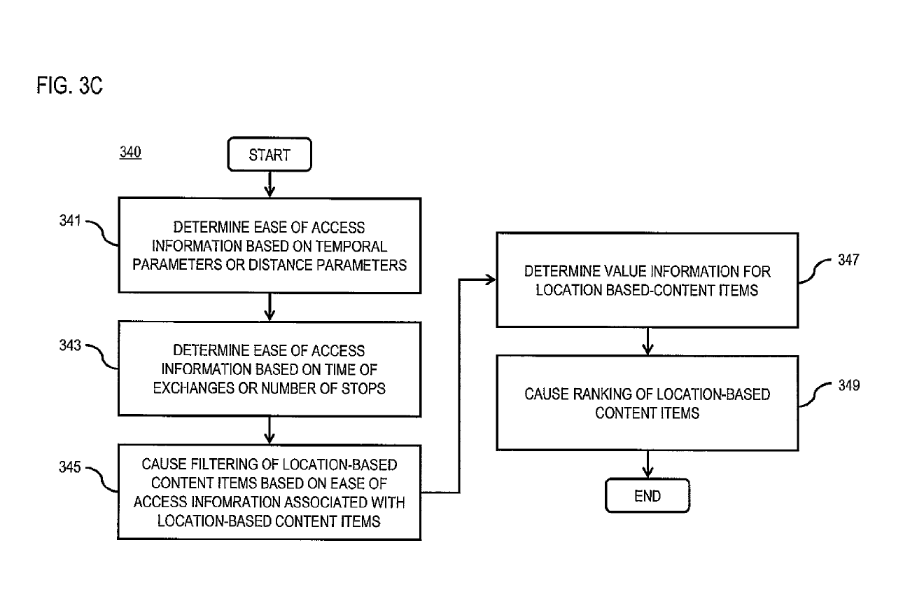

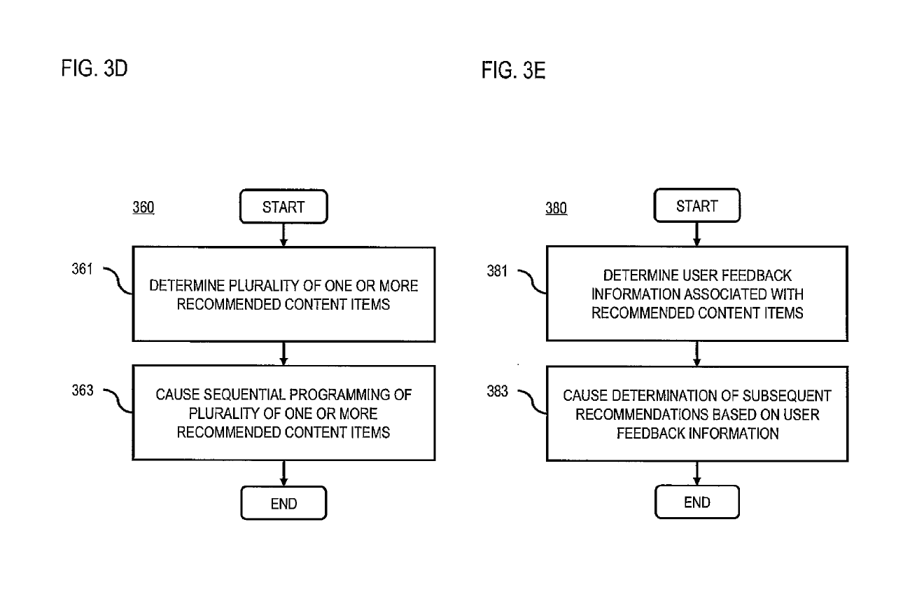

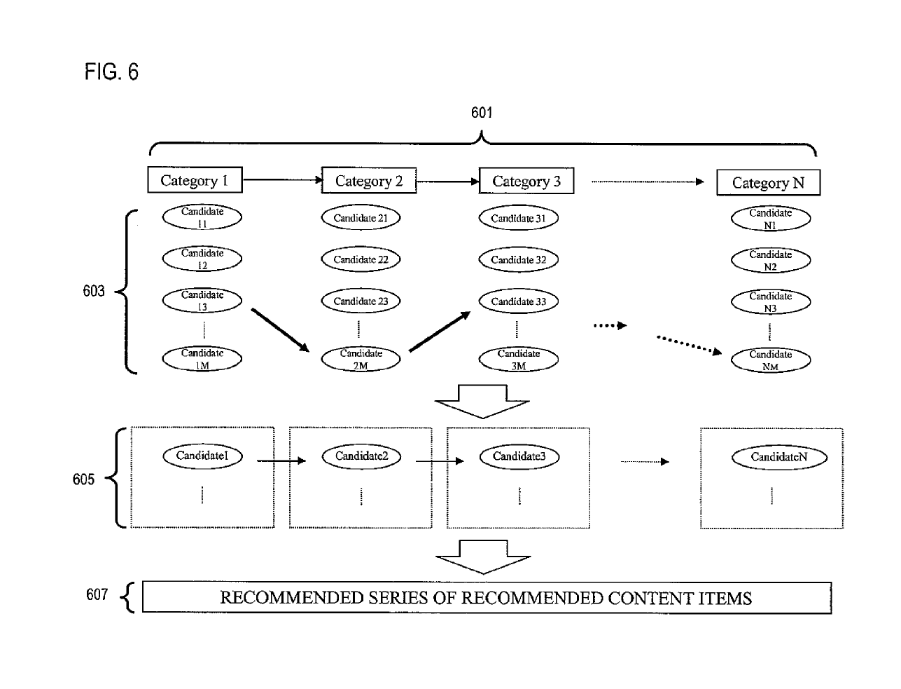

FIGS. 3A-3E are flowcharts of processes for recommending location-based content items that account for locations with ease of access based on available transportation options, according to various embodiment. The ease of access may be the most convenient means or the least overhead cost to access the content items. In various embodiments, the content recommender platform 103 performs the process 300, 320, 340, 360 and 380, and is implemented in, for instance, a chip set including a processor and a memory as shown in FIG. 6.

In step 301 of process 300 (FIG. 3A), the content recommender platform 103 may determine predicted locations of a user based on ease of access from a location associated with the user. The predicted locations may be possible future locations of the user. The location associated with the user may be a current location of the user or an arbitrary location entered by the user. The predicted locations may be determined by scanning through the possible future locations associated with possible transport routes associated with the location.

In step 303, the content recommender platform 103 may determine location-based content items associated with the predicted locations of the user or the location associated with the user. The location-based contents items may be associated with places (e.g., restaurants, shops, theaters, etc.), deals (e.g., coupons, advertisements, etc.), activities (e.g., performance, events, etc.), etc. The predicted locations or the location may be transportation hubs (e.g., stations, terminals, stops, harbors, docks, airports, parking lots, etc.). The location-based content items may be indexed to the transportation hubs. The locations-based content items may be determined by retrieving the indices associated with the predicted locations or the location.

In step 305, the content recommender platform 103 may determine recommended content items from among the location-based content items. The recommended content items may be determined by filtering and ranking the location-based content items. The location-based content items may be filtered based on ease of access information. The filtered content items may be ranked based on the ease of access information. The ease of access information may be determined based on temporal parameters (travel time, transportation schedule, transfer time, wait time, peak time period, time cost, etc.), distance parameters (e.g. distances from the location associated with the user to nearby transportation hubs, distances between the nearby transportation hubs and the predicted locations, distances from the predicted locations to the locations associated with the content items, etc.), or combination thereof. The ease of access information may also be determined based on a time/number of exchanges, a number of stops/stations, or combinations thereof. For example, the locations-based content items associated with shorter distances/time and/or lesser exchanges/stops may be ranked higher than other location-based content items associated with longer distance/time and/or more exchanges/stops. The location-based content items with high ranks may be determined as the recommended content items.

In step 321 of process 320 (FIG. 3B), the content recommender platform 103 may cause an indexing of the location-based content items based on the predicted locations of the user or the location associated with the user. The predicted locations or the location may be the transportation hubs (e.g., stations, terminals, stops, harbors, docks, airports, parking lots, etc.). The location-based content items may be pre-indexed to the transportation hubs in advance.

In step 323, the content recommender platform 103 may determine transport routes associated with the location associated with the user. The transport routes may be determined by scanning through possible transportation routes associated with the location.

In step 325, the content recommender platform 103 may determine the predicted locations, the ease of access from the location, or a combination thereof based on the transportation hubs associated with the transport routes. The predicted locations may be the transportation hubs. In certain embodiments, the transport routes may include public transportation routes (e.g., bus routes, subway lines, train tracks, etc.), and the transportation hubs may include public transportation stops (e.g., bus stops, subway stations, ferry docks, etc.).

In step 327, the content recommender platform 103 may cause an aggregation of the location-based content items. The location-based content items may be aggregated based on the predicted locations determined in step 325 or the location associated with the user. The location-based items may be searched by retrieving the indices associated with the predicted locations or the location.

In step 341 of process 340 (FIG. 3C), the content recommender platform 103 may determine ease of access information based on temporal parameters, distance parameters, or combination thereof. The temporal parameters may include travel time, transportation schedule, transfer time, wait time, peak time period, time cost, etc. For example, wait time of 30 minutes for a restaurant during a peak lunch hour may be considered as a basis along with the travel time to the restaurant in determining the ease of access information. The distance parameters may include distances from the location associated with the user to nearby transportation hubs, distances between the nearby transportation hubs and the predicted locations, distances from the predicted locations to the locations associated with the content items, etc. A combination of the temporal parameters and the distance parameters may be considered as bases in determining the ease of access information.

In step 343, the content recommender platform 103 may determine ease of access information based on a time of exchanges, a number of stops, or a combination thereof. The time of exchanges may include a time of switches to different transport modes, a time of transfers to different lines, etc. The number of stops may include a number of traffic signals, a number of stations or transportation hubs, etc. The number of exchanges and the number of stops may be considered as bases in determining the ease of access information. For example, when a location-based content is accessible by taking 2 different subway lines and passing 5 subway stations, the ease of access information for the location-based content may be determined based on the 1 exchange and 5 stops. Traveling to a farther place with less transfers and stops may be easier than traveling to closer place with more transfers and stops.

In step 345, the content recommender platform 103 may cause a filtering of the location-based items based on ease of access information associated with the predicted locations. The location-based items may be filtered based on parameters associated that accounts for locations with ease of access based on available transportation options. The parameters may be a predefined value or user input value. For example, location-based content items may be filtered based on a maximum number of exchanges and stops provided by the user. The location-based content items may be filtered if the number of exchanges and stops required to access the location-based content items is equal or less than the maximum number of exchanges and stops. The determination of the recommended content items (step 305) may be based on the filtering. By way of example, a simplified approach to filter the location-based content items based on the ease of access is as following:

Where α and β are predefined parameters to control the maximum stops and times of exchanges,

1. Initially empty location-based content items set C.

2. Find all stops near a user location (distance is less than d) as S;

3. For each stop s in S

For each line 1 where s is in l
Call FilterContents (s, l, C, 0, l)
   *FilterContents (s, l, C, e, n) // e indicates the time of line exchanges and n indicates the number of taking stops

for (i=n; i<α; i++)
Add the contents items near s into C;
s=NextStop (l, s) // the next stop of s in line l
if (e<β)
   for each line l′ where s is in l′ and l′≠l
   FilterContents (s, l, C, e++, i)

In step 347, the content recommender platform 103 may determine value information associated with the location-based content items. The value information may include value of coupons, value of deals, costs to access the location-based content items, non-monetary value, etc. The value information may be provided by the content provider 117. The value information may also be generated based on user feedbacks.

In step 349, the content recommender platform 103 may cause a ranking of location-based content items. The location-based content items may be ranked based on features of the location-based content items and weights of the features. By way of example, a logistic model for the ranking may be logScore(c)=w₁*f₁+w₂*f₂+ . . . +wₙ*fₙ, where Score(c) indicates the ranking score of content c, and fₗ and wₗ indicated the i-th feature and the corresponding weight.

The features may include ease of access, values, ratings, popularity, etc. The weights of the features may be determined manually or learned through learning algorithm. The learning algorithm may capture user feedbacks from social networking services. Examples of the user feedbacks may include user comments, recommendations, reviews, ratings, votes, likes, shares, etc. The determination of the recommended items (step 305) may be based on the ranking.

In step 361 of process 360 (FIG. 3D), the content recommender platform 103 may determine a plurality of the recommended content items. The recommended content items may be determined in multiple categories thereby forming a plurality of the recommended content items. The multiple categories may include restaurants, banks, hair salon, theaters, florists, gas stations, convenient store, laundry shop, etc. For each category selected, the recommended content items may be determined. For example, if a user wants to find not only a restaurant, but also a theater and a pub that accounts for locations with ease of access based on available transportation options, then the recommended content items may be determined for restaurants, theaters, and pubs.

In step 363, the content recommender platform 103 may cause a sequential programming of the plurality of the recommended content items. The sequential programming may cause combining of the plurality of the recommended content items in series based on best path search functions. The series of recommended content items may be ranked based on the optimized function (e.g. Sum(logScore)). The higher ranked series may be recommended over the other lower ranked series. For example, a combination of the recommended content items consisting of a restaurant candidate #1, a theater candidate #3, and a pub candidate #5 may be recommended over another combination of the recommended content items consisting of a restaurant candidate #2, a theater candidate #4, and a pub candidate #6.

In step 381 of process 380 (FIG. 3E), the content recommender platform 103 may determine user feedback information associated with the recommended content items. The user feedback information may be determined based on user comments, recommendations, reviews, ratings, votes, likes, shares, etc. The user feedback information may be captured from social networking services, recommender services, review services, surveys, etc. For example, positive comments, shared information or likes about a restaurant's deal on a social networking service may be captured and used as bases in determining subsequent recommendations of the restaurant's similar deal for another user.

In step 383, the content recommender platform 103 may cause determination of subsequent recommendations based on the user feedback information. The user feedback information may be positive, negative, or neutral and may be weighted accordingly in determining subsequent recommendations. For example, positive feedback information may cause a restaurant's deal more recommendable than negative feedback information.

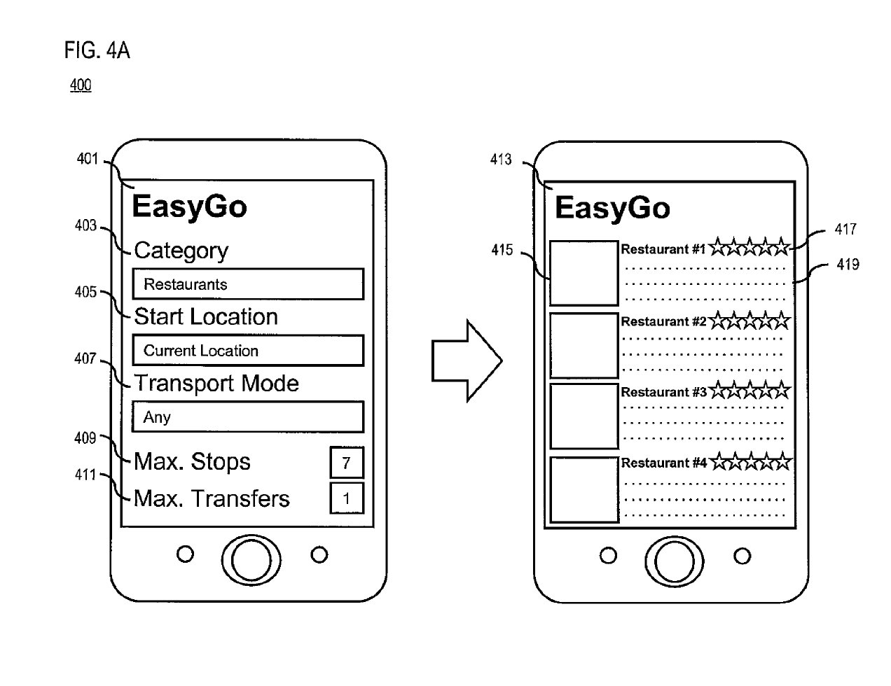

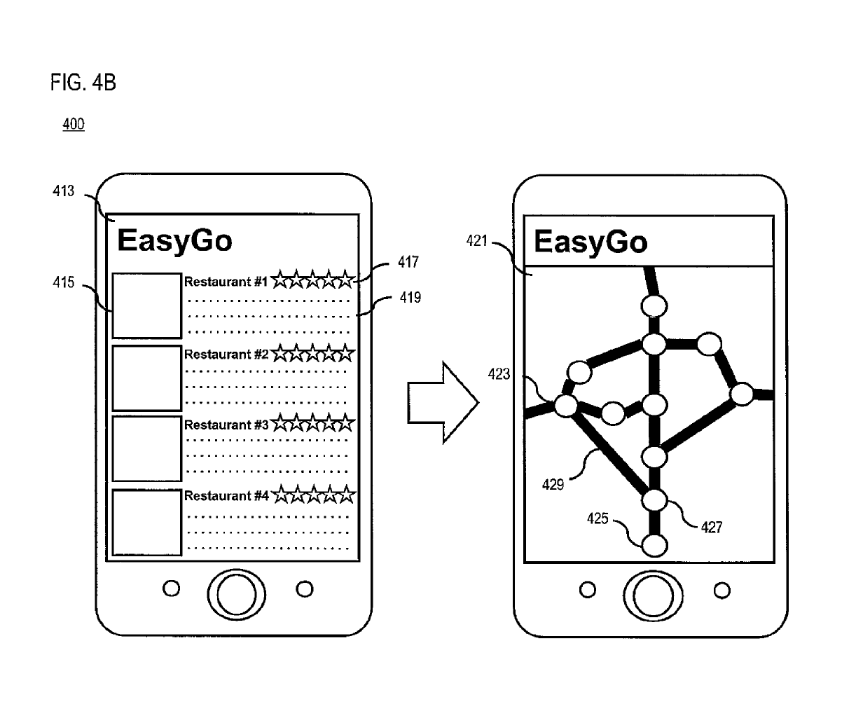

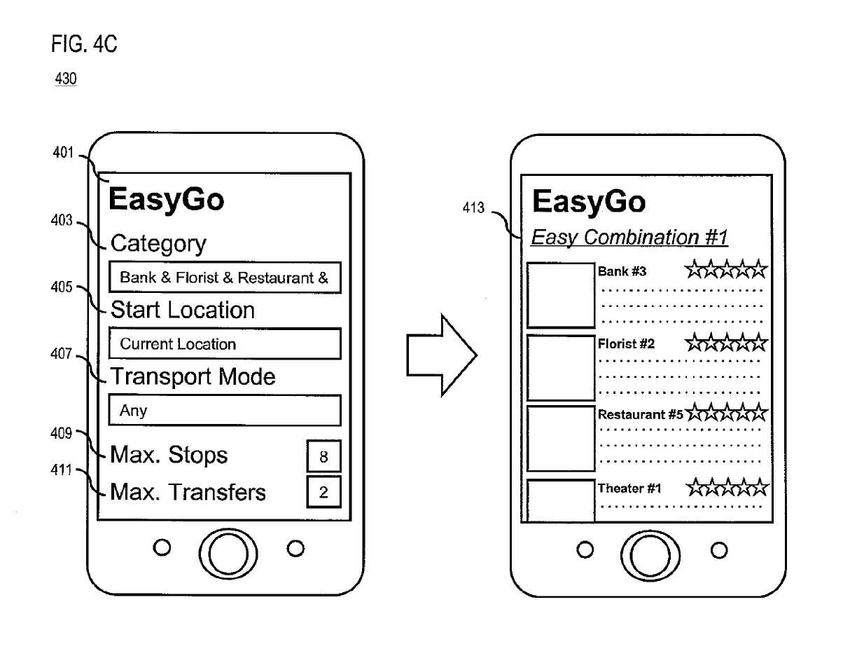

FIGS. 4A-4D are diagrams of user interfaces utilized in the processes of FIGS. 3A-3E, according to various embodiments. For the purpose of illustration, the diagrams are described with respect to an exemplary case of the content recommender platform 103 presenting recommended content items that account for locations with ease of access based an available transportation options of via the application 107 on the UE 101.

FIGS. 4A-4B depict one embodiment in which determination of recommended content items based on user entries is presented on a UE 101. The UE 101 may display via application 107 an initial entry page 401, a recommendation page 413, and a mapping page 421. The initial entry page 401 may include user entry slots for a category of content items 403, a start location 405, a transport mode 407, maximum number of stops 409, and maximum number of transfers 411. The user input slots may be typed-in or selected from available choices. The recommendation page 413 may include a picture 415, a rating 417, a description 419 of the recommended content items, etc. The recommended content items may be presented in order of the rank. The mapping page 421 may include a start location 425, a location of recommended item 423, and a route 429, a transportation hub 427, etc. For example, the FIG. 4A illustrates a transition from initial entry page 401 to the recommendation page 413. In one scenario, the user is looking for a restaurant, easily accessible by any transport mode within 7 stops and 1 transfer. As a result of the user entry, the recommended restaurants that accounts for locations with ease of access based on available transportation options are presented in order of the rank. The FIG. 4B illustrates a transition from the recommendation page 413 to the mapping page 421. Here, the user selects one of the recommended restaurants and as a result, a direction to the recommended restaurant is presented on the mapping page 421.

FIG. 4C depicts one embodiment in which determination of a pluralities of recommended content items based on user entries is presented on the UE 101. In the initial entry page 401, the category of content items 403 may allow users to choose a plurality of categories to be combined. The recommendation page 413 may display a plurality of combined content items in series. For example, the FIG. 4C illustrates another transition from initial entry page 401 to the recommendation page 413. In one scenario, the user is looking for a bank, a florist, a restaurant and a theater, easily accessible by any transport mode within 8 stops and 2 transfers. As a result, a combination of Bank #3, Florist #2, Restaurant #5, and Theater #1 is present in a series as one of the recommended combinations.

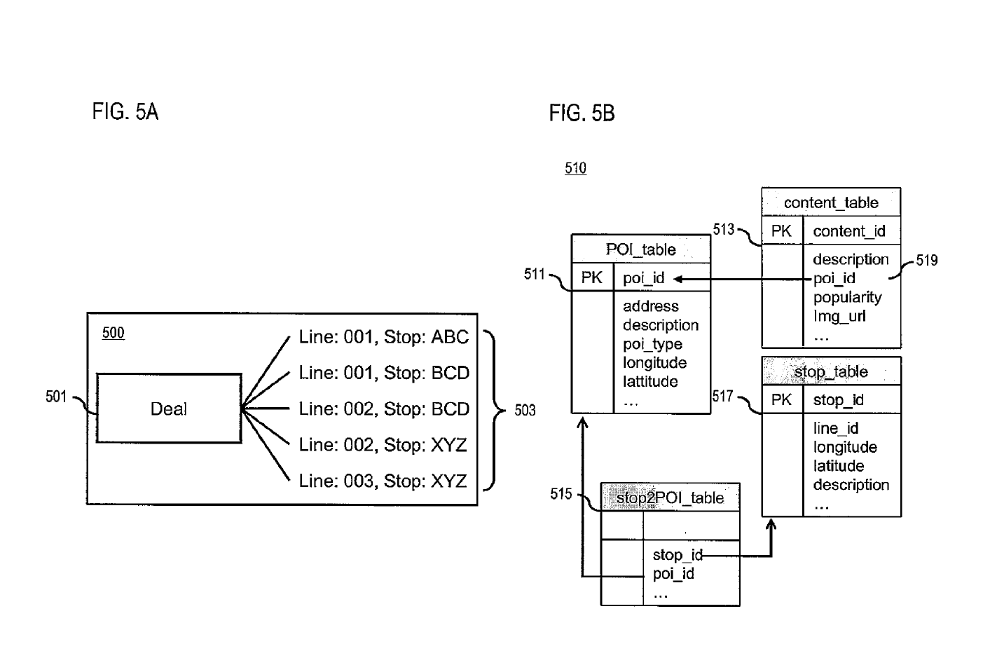

FIGS. 5A-5B are diagrams illustrating a process of indexing the location-based contents with the transportation hubs, according to various embodiments. FIG. 5A depicts one embodiment in which a content item 501 is indexed to different transportation hubs 503 in different routes. The Deal is indexed to different stops, ABC, BCD, and XYZ in different lines, 001, 002, and 003. FIG. 5B is an illustration of simplified approach for indexing the location-based contents with the transportation hubs. In a data table for the location-based contents (content_table) 513, an attribute (content_id) 519 is assigned to indicate its binding with the data table for the POIs (POI_table) 511. A many-to-many relationship data table (stop2POI_table) 515 has two columns, POI_id and stop_id, each indicating their binding with POI_table and stop_table, respectively. An entry <p,s> in stop2POI_table may indicate whether the distance between the POI p and transportation hub s is less than a predefined threshold d.

FIG. 6 is a diagram illustrating a process of sequential programming of the plurality of the recommended content items, according to various embodiments. For each category 601, candidates 603 of recommend content items may be determined. One candidate from each category may be combined with other candidates from other candidates in series 605 based on best path search functions. If there are N different categories and M candidates for each category, M different series of N different recommended content items may be formed. The series 605 of candidates 603 may be ranked based on the optimized function (e.g., Sum(logScore)). The higher ranked series 607 may be recommended over the other lower ranked series.

The processes described herein for recommending location-based content items that account for locations with ease of access based on available transportation options may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

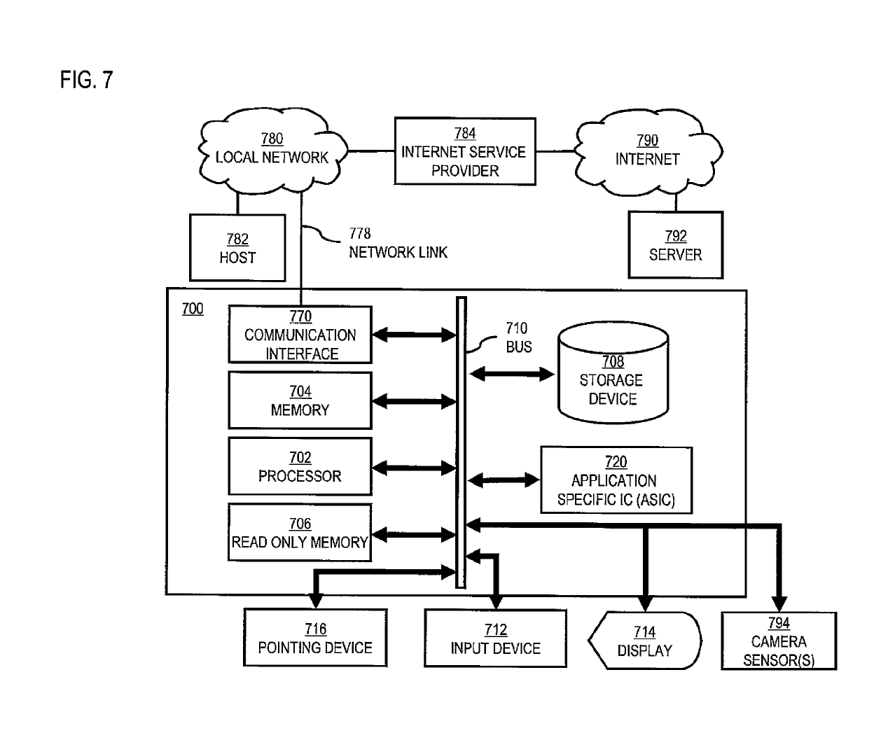

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700.

Computer system 700 is programmed (e.g., via computer program code or instructions) to recommend location-based content items that account for locations with ease of access based on available transportation options as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of recommending location-based content items that account for locations with ease of access based on available transportation options.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to recommend location-based content items that account for locations with ease of access based on available transportation options. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions.

Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for recommending location-based content items that account for locations with ease of access based on available transportation options. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for recommending location-based content items that account for locations with ease of access based on available transportation options, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communicaₜion interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for recommending location-based content items that account for locations with ease of access based on available transportation options to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

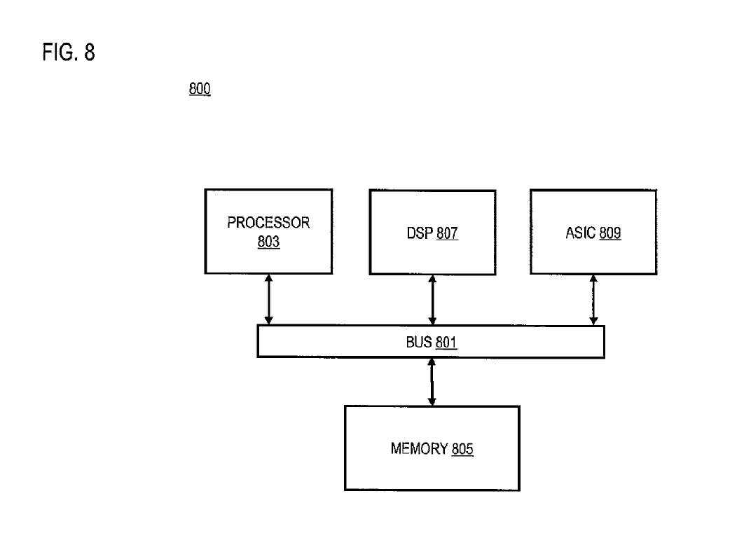

FIG. 8 illustrates a chip set or chip 800 upon which an embodiment of the invention may be implemented. Chip set 800 is programmed to recommend location-based content items that account for locations with ease of access based on available transportation options as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of recommending location-based content items that account for locations with ease of access based on available transportation options.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to recommend location-based content items that account for locations with ease of access based on available transportation options. The memory 805 also stores the data associated with or generated by the execution of the inventive steps.

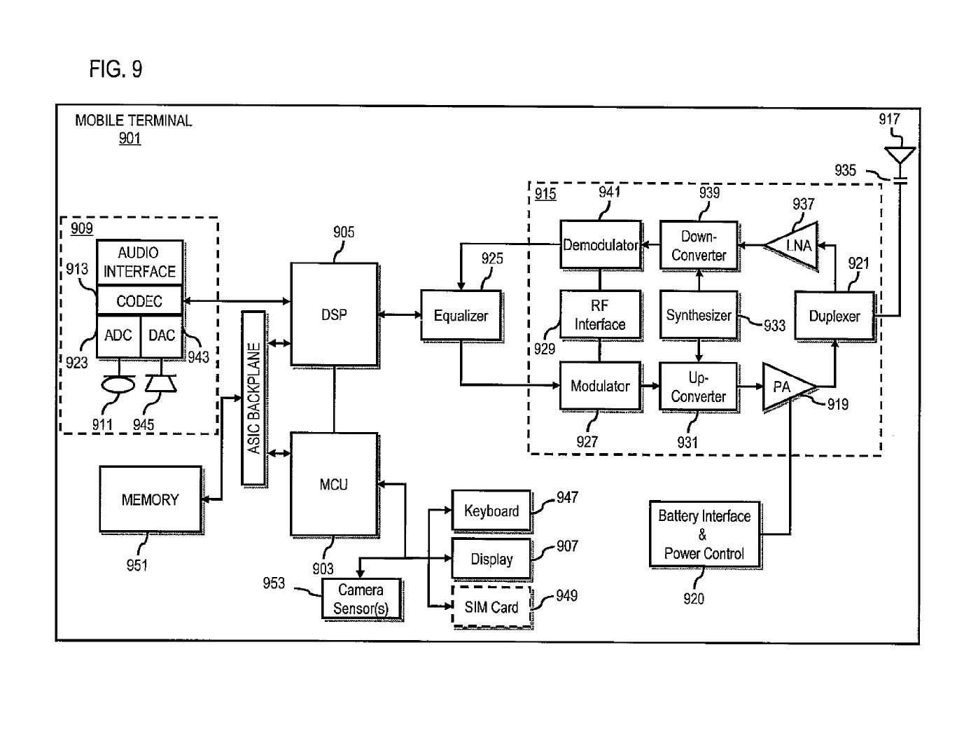

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of recommending location-based content items that account for locations with ease of access based on available transportation options. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of recommending location-based content items that account for locations with ease of access based on available transportation options. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level, In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream.

The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to recommend location-based content items that account for locations with ease of access based on available transportation options. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-41. (canceled)

42. A method comprising facilitating a processing of and/or processing (1) data and/or (2) information and/or (3) at least one signal, the (1) data and/or (2) information and/or (3) at least one signal based, at least in part, on the following:
at least one determination of one or more predicted locations of a user based, at least in part, on an ease of access from a location associated with the user;
at least one determination of one or more location-based content items associated with the one or more predicted locations, the location, or a combination thereof; and
at least one determination of one or more recommended content items from among the one or more location-based content items.

43. A method of claim 42, wherein the (1) data and/or (2) information and/or (3) at least one signal are further based, at least in part, on the following:
at least one determination of one or more transport routes associated with the location; and
at least one determination of the one or more predicted locations, the ease of access from the location, or a combination thereof based, at least in part, on one or more transportation hubs associated with the one or more transport routes.

44. A method of claim 43, wherein the one or more transport routes include, at least in part, one or more public transportation routes, and wherein the one or more transportation hubs include, at least in part, one or more public transportation stops.

45. A method of claim 42, wherein the (1) data and/or (2) information and/or (3) at least one signal are further based, at least in part, on the following:
an aggregation of the one or more location-based content items associated with the one or more predicted location, the location, or a combination thereof; and
a ranking of the one or more location-based content items in the aggregation,
wherein the determining of the one or more recommended items is based, at least in part, on the ranking.

46. A method of claim 42, wherein the (1) data and/or (2) information and/or (3) at least one signal are further based, at least in part, on the following:
an indexing of the one or more location-based content items based, at least in part, on the one or more predicted locations, the location, or a combination thereof.

47. A method of claim 42, wherein the (1) data and/or (2) information and/or (3) at least one signal are further based, at least in part, on the following:
a filtering of the one or more location-based content items based, at least in part, on ease of access information associated the one or more location-based content items,
wherein the determining of the one or more location-based content items, the determining of the one or more recommended content items, or a combination thereof is based, at least in part, on the filtering.

48. A method of claim 47, wherein the (1) data and/or (2) information and/or (3) at least one signal are further based, at least in part, on the following:
at least one determination of the ease of access information based, at least in part, on one or more temporal parameters, one or more distance parameters, or a combination thereof.

49. A method of claim 47, wherein the (1) data and/or (2) information and/or (3) at least one signal are further based, at least in part, on the following:
at least one determination of the ease of access information based on, at least in part, a time of exchanges, a number of stops, or a combination thereof.

50. A method of claim 42, wherein the (1) data and/or (2) information and/or (3) at least one signal are further based, at least in part, on the following:
at least one determination of value information for the one or more location-based content items,
wherein the determining of one or more recommended content items is based, at least in part, on the value information.

51. A method of claim 42, wherein the (1) data and/or (2) information and/or (3) at least one signal are further based, at least in part, on the following:
at least one determination of a plurality of the one or more recommended content items; and
a sequential programming of the plurality of the one or more recommended content items.

52. A method of claim 42, wherein the (1) data and/or (2) information and/or (3) at least one signal are further based, at least in part, on the following:
at least one determination of user feedback information associated with the one or more recommended content items; and
a determination of one or more subsequent recommendations based, at least in part, on the user feedback information.

53. An apparatus comprising:
at least one processor; and
at least one memory including computer program code for one or more programs,
the at least one memory and the computer program code configured to, with the at least one processor, cause the apparatus to perform at least the following,
determine one or more predicted locations of a user based, at least in part, on an ease of access from a location associated with the user;
determine one or more location-based content items associated with the one or more predicted locations, the location, or a combination thereof; and
determine one or more recommended content items from among the one or more location-based content items.

54. An apparatus of claim 53, wherein the apparatus is further caused to:
determine one or more transport routes associated with the location; and
determine the one or more predicted locations, the ease of access from the location, or a combination thereof based, at least in part, on one or more transportation hubs associated with the one or more transport routes.

55. An apparatus of claim 54, wherein the one or more transport routes include, at least in part, one or more public transportation routes, and wherein the one or more transportation hubs include, at least in part, one or more public transportation stops.

56. An apparatus of claim 53, further comprising:
causing, at least in part, an aggregation of the one or more location-based content items associated with the one or more predicted location, the location, or a combination thereof; and
causing, at least in part, a ranking of the one or more location-based content items in the aggregation,
wherein the determining of the one or more recommended items is based, at least in part, on the ranking.

57. An apparatus of claim 53, further comprising:
causing, at least in part, an indexing of the one or more location-based content items based, at least in part, on the one or more predicted locations, the location, or a combination thereof.

58. An apparatus of claim 53, further comprising:
causing, at least in part, a filtering of the one or more location-based content items based, at least in part, on ease of access information associated the one or more location-based content items,
wherein the determining of the one or more location-based content items, the determining of the one or more recommended content items, or a combination thereof is based, at least in part, on the filtering.

59. An apparatus of claim 58, further comprising:
determining the ease of access information based, at least in part, on one or more temporal parameters, one or more distance parameters, or a combination thereof.

60. An apparatus of claim 58, further comprising:
determining the ease of access information based on, at least in part, a time of exchanges, a number of stops, or a combination thereof.

61. An apparatus of claim 53, further comprising:
determining value information for the one or more location-based content items,
wherein the determining of one or more recommended content items is based, at least in part, on the value information.

62. An apparatus of claim 53, further comprising:
determining a plurality of the one or more recommended content items; and
causing, at least in part, a sequential programming of the plurality of the one or more recommended content items.

63. An apparatus of claim 53, further comprising:
determining user feedback information associated with the one or more recommended content items; and
causing, at least in part, a determination of one or more subsequent recommendations based, at least in part, on the user feedback information.

64. An apparatus of claim 53, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.
